(19) United States
(12) Patent Application Publication
(10) Pub. No.: US 2026/0029732 A1
(43) Pub. Date: Jan. 29, 2026

(54) IMAGE FORMING APPARATUS

(71) Applicant: FUJIFILM BUSINESS INNOVATION CORP., Tokyo (JP)

(72) Inventor: Yu TSUDA, Kanagawa (JP)

(73) Assignee: FUJIFILM BUSINESS INNOVATION CORP., Tokyo (JP)

(21) Appl. No.: 19/032,676

(22) Filed: Jan. 21, 2025

(30) Foreign Application Priority Data
Jul. 25, 2024 (JP) 2024-119600
Jul. 25, 2024 (JP) 2024-119601

(51) Int. Cl. G03G 15/095; G03G 21/00

(52) U.S. Cl. CPC G03G 15/095; G03G 21/0011; G03G 2221/0089

(57) ABSTRACT

An image forming apparatus includes: an image carrier that is provided to be rotatable about a rotation axis and that carries an image; and a removing portion that removes powder adhering to an outer peripheral surface of the image carrier by coming into contact with the outer peripheral surface of the image carrier that rotates, in which one set of an image forming section that includes the image carrier and the removing portion and that forms an image is provided or a plurality of sets of the image forming sections are provided, and in which, in the one set of the image forming section or in at least one image forming section among the plurality of sets of the image forming sections, a contact location that is a location at which the removing portion comes into contact with the outer peripheral surface of the image carrier is located below an imaginary horizontal plane passing through the rotation axis of the image carrier.

### CROSS-REFERENCE TO RELATED APPLICATIONS

This application is based on and claims priority under 35 USC 119 from Japanese Patent Application No. 2024-119600 filed Jul. 25, 2024 and Japanese Patent Application No. 2024-119601 filed Jul. 25, 2024.

### BACKGROUND

### (i) Technical Field

The present disclosure relates to an image forming apparatus.

### (ii) Related Art

For example, Japanese Unexamined Patent Application Publication No. 2006-91038 discloses a collection device that includes multiple waste-toner collection sections, a collection box that stores waste toner collected at the waste-toner collection sections, and a waste-toner transport path through which waste toner collected at the waste-toner collection sections is transported to the collection box. Among multiple waste-toner collection sections, a waste-toner collection section at which waste toner having low flowability is collected is connected to the further downstream side of the waste-toner transport path than the other waste-toner collection sections.

### SUMMARY

Here, an image forming apparatus may be considered to be provided with a component including a rotatably-provided image carrier and a removing portion that removes powder adhering to the outer peripheral surface of the image carrier that rotates. When the amount of the powder to be removed is large and when a location at which the removing portion removes the powder from the outer peripheral surface of the image carrier is located above an imaginary horizontal plane that includes a rotation axis, the following inconveniences may occur. The removed powder may remain at the location of removal without moving downward. When the amount of the powder remaining at the location at which the powder is removed becomes excessively large, removing performance of removing powder from the outer peripheral surface of the image carrier by the removing portion may decrease.

Aspects of non-limiting embodiments of the present disclosure relate to suppressing a decrease in the removing performance of removing powder from the image carrier compared with that when the location at which the removing portion removes powder from the outer peripheral surface of the image carrier is located above the imaginary horizontal plane that includes the rotation axis.

In addition, here, an image forming apparatus may be considered to be provided with multiple sets of components each including a scraping portion that scrapes off powder adhering to an outer peripheral surface of an image carrier that rotates and a storage section that stores scraped powder. When the scraped powder is stored in the storage section by passing through a gap between an arrangement member including at least a portion disposed below the scraping portion and the outer peripheral surface of the image carrier, the following inconvenience may occur. When the amount of the scraped powder is different among the sets and when multiple sets of storage sections have the same capacity, the upper surface of the powder stored in each storage section in the sets in which the amount of the powder is large may become high to approach the gap and may become impossible to be stored. Consequently, it may become difficult for powder to pass through the gap, which may decrease scraping performance of scraping powder from the outer peripheral surface of the image carrier by the scraping portion.

Aspects of non-limiting embodiments of the present disclosure also relate to suppressing a decrease in the scraping performance of scraping powder from the image carrier compared with that when the multiple sets of the storage sections have the same capacity.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: an image carrier that is provided to be rotatable about a rotation axis and that carries an image; and a removing portion that removes powder adhering to an outer peripheral surface of the image carrier by coming into contact with the outer peripheral surface of the image carrier that rotates, in which one set of an image forming section that includes the image carrier and the removing portion and that forms an image is provided or a plurality of sets of the image forming sections are provided, and in which, in the one set of the image forming section or in at least one image forming section among the plurality of sets of the image forming sections, a contact location that is a location at which the removing portion comes into contact with the outer peripheral surface of the image carrier is located below an imaginary horizontal plane passing through the rotation axis of the image carrier.

### BRIEF DESCRIPTION OF THE DRAWINGS

Exemplary embodiments of the present disclosure will be described in detail based on the following figures, wherein:

FIG. 1 illustrates an image forming apparatus according to an exemplary embodiment;

FIG. 2 illustrates a developing device of an image forming apparatus;

FIG. 3 illustrates the surroundings of a photoconductor drum of an image forming apparatus;

FIGS. 4A and 4B illustrate one example of the positional relationship between a photoconductor drum and a drum cleaner in multiple sets of image forming units according to a first exemplary embodiment, FIG. 4A illustrating one set of the image forming unit, FIG. 4B illustrating another set of the image forming unit;

FIGS. 5A and 5B illustrate another example of the positional relationship between a photoconductor drum and a drum cleaner in multiple sets of image forming units, FIG. 5A illustrating one set of the image forming unit, FIG. 5B illustrating another set of the image forming unit;

FIGS. 6A and 6B illustrate an example of the positional relationship between a blade and a transport member in a drum cleaner, FIG. 6A illustrating one example with a partition member, FIG. 6B illustrating another example with no partition member;

FIG. 7 illustrates one example of the arrangement of multiple sets of image forming units with an intermediate transfer belt;

FIG. 8 illustrates another example of the arrangement of multiple sets of image forming units with an intermediate transfer belt;

FIGS. 9A and 9B illustrate one example of a drum cleaner in multiple sets of image forming units according to a second exemplary embodiment, FIG. 9A illustrating one set of the image forming unit, FIG. 9B illustrating another set of the image forming unit;

FIGS. 10A and 10B illustrate another example of a drum cleaner in multiple sets of image forming units, FIG. 10A illustrating one set of the image forming unit, FIG. 10B illustrating another set of the image forming unit; and

FIG. 11 illustrates one example of the arrangement of multiple sets of image forming units with an intermediate transfer belt.

### DETAILED DESCRIPTION

Hereinafter, exemplary embodiments of the present disclosure will be described with reference to the accompanying drawings.

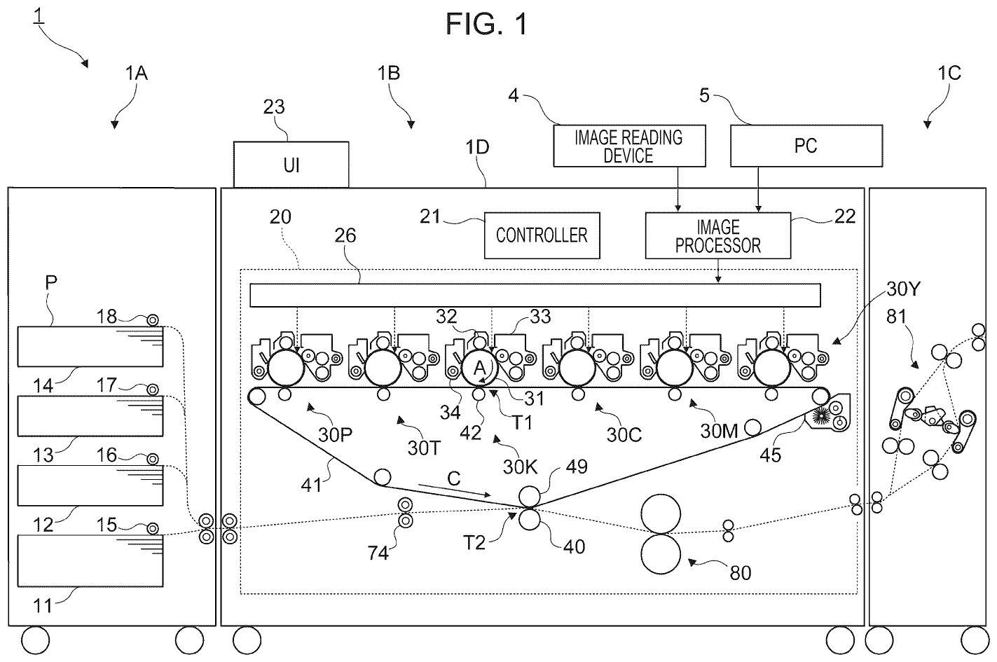

FIG. 1 illustrates an image forming apparatus 1 according to an exemplary embodiment.

The image forming apparatus 1 according to the exemplary embodiment includes a sheet feeding unit 1A, a printing unit 1B, and a sheet discharging unit IC.

The sheet feeding unit 1A includes a first sheet storage section 11 to a fourth sheet storage section 14 for storing sheets P.

The sheet feeding unit 1A is provided with feeding rollers 15 to 18 corresponding to the first sheet storage section 11 to the fourth sheet storage section 14, respectively. The feeding rollers 15 to 18 feed the sheets P stored in respective sheet storage sections to a transport path connected to the printing unit 1B.

The printing unit 1B includes an image forming section 20 in which images are to be formed onto the sheets P. The image forming section 20 is mounted by being positioned in a unit body 1D of the printing unit 1B. The unit body ID is one example of the body of the image forming apparatus.

In addition, the printing unit 1B is provided with a controller 21 that controls each part of the image forming apparatus 1.

The printing unit 1B also includes an image processor 22. The image processor 22 performs image processing on image data transmitted from an image reading device 4 or a personal computer (PC) 5.

The printing unit 1B is also provided with a user interface (UI) 23 constituted by a touch panel and the like. The UI 23 notifies a user of information and receives an input from a user.

The image forming section 20 is provided with six image forming units 30T, 30P, 30Y, 30M, 30C, and 30K (hereinafter may be simply referred to as “image forming units 30” or “multiple sets of the image forming units 30”) disposed in parallel at regular intervals. The multiple sets of the image forming units 30 in such a case are devices that form color images and are one example of multiple set of the image forming sections.

The image forming section 20 may be considered to be simply constituted by, for example, the image forming unit 30K. In such a case, the image forming apparatus 1 is an apparatus that forms monochrome images, and the image forming unit 30K is one example of one set of the image forming section.

Each of the image forming units 30 includes a photoconductor drum 31 on which an electrostatic latent image is to be formed while the photoconductor drum 31 rotates in the arrow A direction, and a charging roller 32 that electrically changes a surface of the photoconductor drum 31. Each of the image forming units 30 also includes a developing device 33 that develops an electrostatic latent image formed on the photoconductor drum 31. In addition, each of the image forming units 30 includes a drum cleaner 34 that removes toner and the like on the surface of the photoconductor drum 31.

The image forming section 20 is provided with a laser exposure device 26 that exposes the photoconductor drum 31 of each of the image forming units 30 to laser light.

The laser exposure device 26 is not limited to use laser light to perform exposure of the photoconductor drum 31. For example, each of the image forming units 30 may be provided with a light source such as a light emitting diode (LED), and light emitted from the light source may be used to perform exposure of the photoconductor drum 31.

The image forming units 30 are configured similarly except for the toner stored in the developing device 33. The image forming units 30Y, 30M, 30C, and 30K form a yellow (Y) toner image, a magenta (M) toner image, a cyan (C) toner image, and a black (K) toner image, respectively.

The image forming units 30T and 30P each form a toner image by using a toner corresponding to a corporate color, a foaming toner for braille, a fluorescent color toner, a toner for improving gloss, or the like. In other words, each of the image forming units 30T and 30P forms a toner image by using a special color toner.

The image forming section 20 is provided with an intermediate transfer belt 41 on which toner images of respective colors formed on the photoconductor drums 31 of the image forming units 30 are to be transferred.

In addition, in the image forming section 20, a first transfer roller 42 is provided for each of the image forming units 30 to, at a first transfer section T1, transfer each color toner image onto the intermediate transfer belt 41.

In the image forming section 20, there is also provided a second transfer roller 40 that, at a second transfer section T2, collectively transfers the toner images transferred on the intermediate transfer belt 41 onto the sheet P.

In the image forming section 20, there are further provided a belt cleaner 45 that removes toner or the like on the surface of the intermediate transfer belt 41, and a fixing device 80 that fixes the second-transferred images to the sheet P.

The image forming section 20 performs an image forming operation on the basis of a control signal from the controller 21.

Specifically, in the image forming section 20, the image processor 22 first performs image processing on image data input from the image reading device 4 or the PC 5. Then, the image data on which the image processing has been performed is supplied to the laser exposure device 26.

In, for example, the image forming unit 30M for magenta (M), the charging roller 32 then electrically charges the surface of the photoconductor drum 31. Thereafter, the laser exposure device 26 irradiates the photoconductor drum 31 with laser light modulated by the image data obtained from the image processor 22.

Consequently, an electrostatic latent image is formed on the photoconductor drum 31.

The developing device 33 develops the formed electrostatic latent image to form a magenta toner image on the photoconductor drum 31.

Similarly, a yellow toner image, a cyan toner image, and a black toner image are formed in the image forming units 30Y, 30C, and 30K, respectively, and special color toner images are formed in the image forming units 30T and 30P.

The color toner image formed in each of the image forming units 30 is electrostatically transferred successively by the first transfer roller 42 onto the intermediate transfer belt 41 that rotates in the arrow C direction in FIG. 1, and superimposed toner images are formed on the intermediate transfer belt 41.

The superimposed toner images formed on the intermediate transfer belt 41 are transported by the movement of the intermediate transfer belt 41 to the second transfer section T2 constituted by the second transfer roller 40 and a backup roller 49.

Meanwhile, the sheet P is taken out by, for example, the feeding roller 15 from the first sheet storage section 11 and is then transported to the position of a registration roller 74 via the transport path.

When the superimposed toner images are transported to the second transfer section T2, the sheet P is supplied from the registration roller 74 to the second transfer section T2 in a manner as to synchronize with the timing of the transport of the superimposed toner images.

Then, at the second transfer section T2, the superimposed toner images are electrostatically transferred collectively onto the sheet P by the action of a transfer electric field formed between the second transfer roller 40 and the backup roller 49.

Thereafter, the sheet P on which the superimposed toner images are electrostatically transferred is transported to the fixing device 80.

The fixing device 80 pressurizes and heats the sheet P on which the un-fixed toner images are formed, thereby fixing the toner images to the sheet P.

Then, the sheet P on which fixing has been performed is transported to a sheet stacking section (not illustrated) after passing through a curl correction section 81 provided in the sheet discharging unit IC.

In the image forming apparatus 1 illustrated in FIG. 1, a configuration in which the image forming units 30 transfer toner images onto the intermediate transfer belt 41 is employed. However, the configuration of the image forming apparatus 1 is not limited thereto. That is, it may be considered to employ a configuration in which the image forming units 30 transfer toner images onto the sheet P.

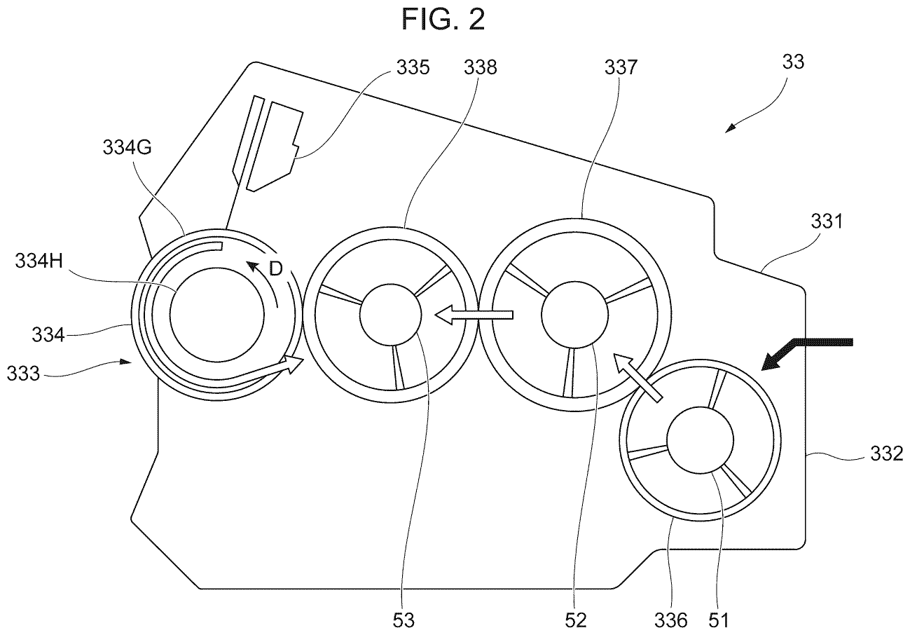

FIG. 2 illustrates the developing device 33 of the image forming apparatus 1 and is a schematic front view of the developing device 33 as viewed in the same direction as in FIG. 1.

As illustrated in FIG. 2, the developing device 33 includes a storage section 331 that stores a developer (not illustrated) in the inside thereof. The storage section 331 is constituted by a storage housing 332 made of resin. The developer is constituted by a magnetic carrier and a colored toner and is a two-component developer as it is called.

The storage housing 332 of the developing device 33 is disposed to extend in a direction orthogonal to the sheet surface of FIG. 2, that is, in the direction from the front side toward the rear side of the image forming apparatus 1 (see FIG. 1). The storage housing 332 includes a front member (not illustrated) on the front side and a back member (not illustrated) on the rear side.

The storage housing 332 is provided with an opening portion 333 at a location to face the photoconductor drum 31 (see FIG. 1). At the opening portion 333, a developing roller 334 that applies a developer to the surface of the photoconductor drum 31 is provided. The developing roller 334 carries the developer that is to be supplied to the photoconductor drum 31. A location at which the developer of the developing roller 334 is supplied to the photoconductor drum 31 may be referred to as the development position.

The developing roller 334 has a cylindrical shape and is disposed to extend in the direction from the front side toward the rear side of the image forming apparatus 1. In addition, the developing roller 334 is disposed along the longitudinal direction of the developing device 33.

The developing roller 334 is provided with a development sleeve 334G that is constituted by a cylindrical body and that is driven to rotate, and a magnet roller 334H that is disposed on the inner side of the development sleeve 334G.

The development sleeve 334G is constituted by, for example, a metal such as SUS. The development sleeve 334G rotates in the arrow D direction in FIG. 2.

In the exemplary embodiment, the development sleeve 334G and the photoconductor drum 31 rotate at the first transfer section T1 (see FIG. 1) for the developing roller 334 and the photoconductor drum 31 such that the development sleeve 334G and the photoconductor drum 31 move in the same direction.

The developing device 33 is provided with a layer regulation member 335 that regulates the layer thickness of the developer carried by the developing roller 334.

As illustrated in FIG. 2, the developing device 33 is also provided with a first transport portion 336, a second transport portion 337, and a third transport portion 338 that transport the developer. Hereinafter, the first transport portion 336, the second transport portion 337, and the third transport portion 338 may be referred to as the transport portions 336 to 338.

The transport portions 336 to 338 are provided on a side of the developing roller 334 opposite to the side thereof where the photoconductor drum 31 (see FIG. 1) is set.

The transport portions 336 to 338 include, respectively, rotary members 51, 52, and 53 that extend along the rotation axis of the development sleeve 334G that is driven to rotate. The transport portions 336 to 338 rotate about the rotary members 51 to 53, respectively. In other words, the transport portions 336 to 338 are disposed substantially parallel to the photoconductor drum 31 (see FIG. 1).

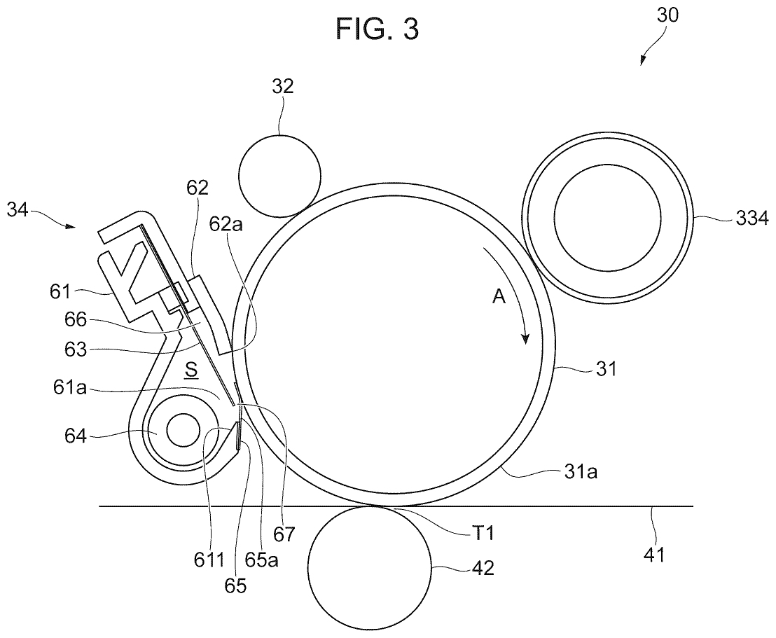

FIG. 3 illustrates the surroundings of the photoconductor drum 31 of the image forming apparatus 1. The photoconductor drum 31 illustrated in FIG. 3 is included in each of the image forming units 30.

The charging roller 32, the developing roller 334, the first transfer roller 42, and the drum cleaner 34, which are described above, are disposed along the arrow A direction around the photoconductor drum 31. Hereinafter, the drum cleaner 34 will be described in detail.

On the downstream side of the first transfer section T1 in the arrow A direction, the drum cleaner 34 cleans a surface 31a of the photoconductor drum 31 and removes toner and the like remaining on the surface 31a after transfer. In addition, the drum cleaner 34 collects a removed substance that has been removed.

The drum cleaner 34 includes a body 61, a blade 62, a partition member 63, a transport member 64, and a contact member 65.

The body 61 holds members, such as the blade 62.

The blade 62 is mounted on the body 61 to be inclined with respect to the surface 31a of the photoconductor drum 31 in the direction opposite to the arrow A direction and cleans the surface 31a by the tip of the blade 62 in contact with the surface 31a.

In the exemplary embodiment, the blade 62 that scrapes off powder such as toner adhering to the surface 31a of the photoconductor drum 31 is employed. The exemplary embodiment is, however, not limited thereto. It may be considered to employ, instead of the blade 62, for example, a brush (not illustrated) that removes powder by rotating.

The partition member 63 is located between the body 61 and the surface 31a of the photoconductor drum 31 and forms a space S that stores a removed substance removed by the blade 62.

The transport member 64 is disposed in the space S to extend along a rotation axis of the photoconductor drum 31. The transport member 64 is a helically extending member. The transport member 64 transports a removed substance by rotating. Consequently, the removed substance is collected. The direction of transport by the transport member 64 is a direction perpendicular to the sheet surface of FIG. 3.

The contact member 65 is located to cover a gap between the body 61 and the partition member 63 such that the space S is formed by the contact member 65 and the partition member 63.

More specifically, the contact member 65 is disposed to extend from the body 61 toward the surface 31a of the photoconductor drum 31.

To describe further, one end portion of the contact member 65 is attached to the body 61 such that the contact member 65 is inclined in the arrow A direction. A tip portion 65a, which is another end portion thereof, is in contact with the surface 31a. A part of the tip portion 65a deforms itself by following, for example, the surface 31a.

More specifically, a toner or the like that passes through a gap between the tip portion 65a of the contact member 65 and the surface 31a of the photoconductor drum 31 is distinguished from a toner or the like that does not pass through the gap. Each of the image forming units 30 is set according to conditions, such as the size of the toner that is to be supplied from the developing roller 334 to the photoconductor drum 31. Such setting is related to the deformation degree depending on the material, the thickness, and the like of the contact member 65, the gap between the tip portion 65a and the surface 31a, or the like.

Consequently, the toner or the like remaining on the surface 31a of the photoconductor drum 31 after transfer passes through the gap between the surface 31a and the tip portion 65a of the contact member 65 and moves to the position of the blade 62. Meanwhile, the removed substance stored in the space S is not allowed to move to the outside of the body 61.

It may be considered to use, for example, a soft resin film or the like as the contact member 65 in the exemplary embodiment.

Here, the partition member 63 forms, together with the contact member 65 and the surface 31a of the photoconductor drum 31, an accumulation section 66 in which the powder removed from the photoconductor drum 31 by the contact member 65 is to be accumulated. With the powder being accumulated in the accumulation section 66, the contact member 65 slides smoothly on the surface 31a of the photoconductor drum 31 when being in contact with the surface 31a.

The partition member 63 has, between the partition member 63 and the surface 31a of the photoconductor drum 31, a gap 67 through which the powder falls below the accumulation section 66. The gap 67 is an outlet through which the powder exits the accumulation section 66. The powder that moves downward from the gap 67 falls along a wall surface 611 of the body 61 to be stored in the body 61. In the exemplary embodiment, the gap 67 is a space between the partition member 63 and the contact member 65.

The body 61 of the drum cleaner 34 has a storage section 61a that stores the powder that has fallen along the wall surface 611. The storage section 61a is located below the body 61. The transport member 64 is rotatably disposed in the storage section 61a.

Here, the photoconductor drum 31 is one example of the image carrier, and the surface 31a of the photoconductor drum 31 is one example of the outer peripheral surface. The blade 62 is one example of the removing portion and is one example of the scraping portion. The partition member 63 is one example of the formation member and is one example of the arrangement member. The storage section 61a is one example of the storage section that stores powder. The transport member 64 is one example of the transport portion. The intermediate transfer belt 41 is one example of the transfer member. The image forming units 30 are one example of one set or multiple sets of the image forming sections and are one example of the multiple image forming sections.

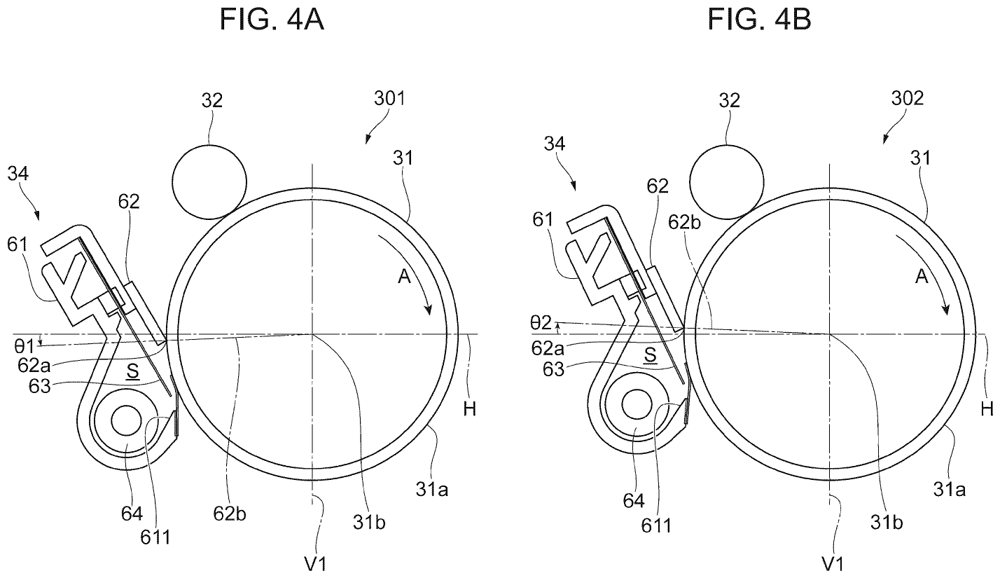

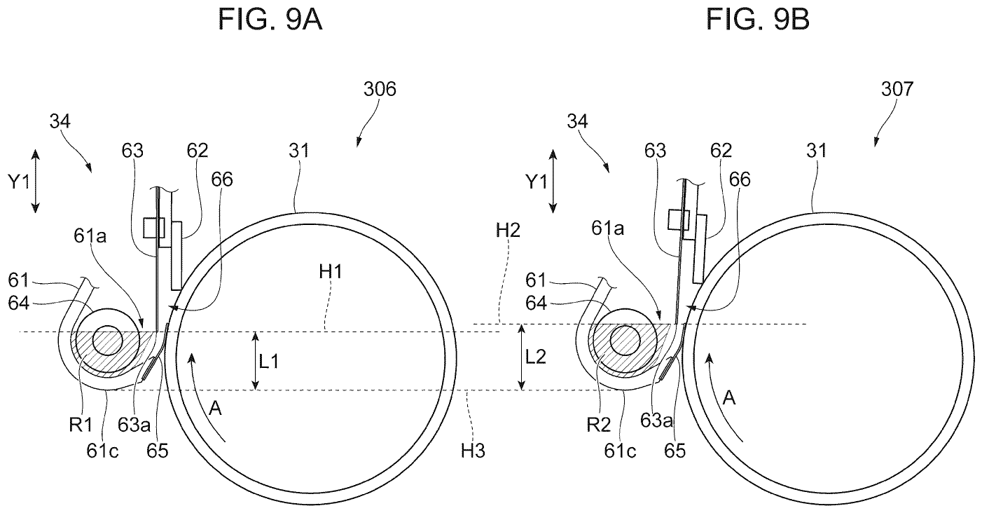

Next, with respect to the exemplary embodiment, a first exemplary embodiment and a second exemplary embodiment will be described. The first exemplary embodiment will be described with FIGS. 4A and 4B to FIG. 8. The second exemplary embodiment will be described with FIGS. 9A and 9B to FIG. 11.

### First Exemplary Embodiment

First, the first exemplary embodiment will be described.

Here, the powder scraped off by the blade 62 in the image forming unit 30 illustrated in FIG. 3 moves downward from the accumulation section 66 through the gap 67 to be stored in the storage section 61a.

However, when the amount of the powder scraped off by the blade 62 is large, the powder accumulated in the accumulation section 66 may have difficulty in moving downward from the gap 67. When the amount of the powder in the accumulation section 66 is increased, the tip portion 65a of the contact member 65 is pressed toward the photoconductor drum 31. Then, the powder does not easily pass through the gap between the tip portion 65a of the contact member 65 and the surface 31a of the photoconductor drum 31. Consequently, a situation in which the powder on the surface 31a is scraped off by the tip portion 65a directly may occur. The powder scraped off by the tip portion 65a of the contact member 65 is likely to stain the image forming units 30, the intermediate transfer belt 41, and the like.

Such a likelihood is similarly present not only when the image forming apparatus 1 includes simply one set of the image forming unit 30 but also when the image forming apparatus 1 includes multiple sets of the image forming units 30.

The amount of the powder scraped off by the blade 62 is not always the same among multiple sets of the image forming units 30 and different depending on, for example, the ratios of toners of developed images. For example, the amount of the powder scraped off by the blade 62 may be also different among the image forming units 30Y, 30M, 30C, and 30K. In addition, the amount of the powder scraped in each of the multiple sets of the image forming units 30 is generally larger in each of the image forming units 30T and 30P than in the image forming units 30Y, 30M, 30C, and 30K.

In each of such image forming units 30 in which the amount of scraped powder is large, removed powder may remain in the accumulation section 66 without being discharged smoothly from the accumulation section 66. When the amount of remaining powder becomes excessively large, the removing performance of removing powder from the surface 31a of the photoconductor drum 31 by the blade 62 may decrease.

Here, it may be possible in the first exemplary embodiment to suppress a decrease in the removing performance by causing the powder removed by the blade 62 to be smoothly discharged from the accumulation section 66.

FIGS. 4A and 4B illustrate one example of the positional relationship between the photoconductor drum 31 and the drum cleaner 34 in multiple sets of the image forming units according to the first exemplary embodiment. FIGS. 4A and 4B illustrate one set of an image forming unit 301 and another set of an image forming unit 302, respectively, among multiple sets of the image forming units. In FIGS. 4A and 4B, illustration of the developing device 33 (see FIG. 1) and the like is omitted. The image forming unit 301 in FIG. 4A will be described assuming that the amount of powder removed by the blade 62 is larger in the image forming unit 301 than in the image forming unit 302 in FIG. 4B.

When the above-described one set of the image forming unit is simply included instead of multiple sets of the image forming units, the configuration illustrated in FIG. 4A is employed.

In the image forming unit 301 illustrated in FIG. 4A, the photoconductor drum 31 is provided to be rotatable about a rotation axis 31b. More specifically, the photoconductor drum 31 rotates about the rotation axis 31b in the clockwise direction, that is, in the arrow A direction.

The blade 62 of the drum cleaner 34 removes powder such as toner adhering to the surface 31a of the photoconductor drum 31 by coming into contact with the surface 31a of the photoconductor drum 31 that rotates. The blade 62 comes into contact at a contact location 62a to the surface 31a of the photoconductor drum 31.

In the image forming unit 301 illustrated in FIG. 4A, the contact location 62a is located below an imaginary horizontal plane H that passes through the rotation axis 31b. In contrast, in the image forming unit 302 illustrated in FIG. 4B, the contact location 62a is located above the imaginary horizontal plane H that passes through the rotation axis 31b. Therefore, the wall surface 611 of the body 61 in the image forming unit 301 has a steeper slope than the wall surface 611 in the image forming unit 302 and causes the powder removed by the blade 62 to slide down easily.

With such a configuration, the powder removed by the blade 62 is smoothly discharged from the accumulation section 66. The accumulation section 66 is one example of the space that temporarily holds powder removed by the removing portion. The above-described gap 67 (see FIG. 3) is one example of the gap through which powder in the space passes downward.

In each of the photoconductor drums 31 illustrated in FIGS. 4A and 4B, a plane coordinate with the rotation axis 31b as the origin of an orthogonal coordinate system, the imaginary horizontal plane H as the X-axis, and an imaginary vertical plane V1 as the Y-axis is considered. The X-axis and the Y-axis are not illustrated in FIGS. 4A and 4B.

A part in which the value in the X-axis is negative and the value in the Y-axis is positive is defined as a second quadrant, and a part in which the value in the X-axis and the value in the Y-axis are both negative is defined as a third quadrant. The contact location 62a illustrated in FIG. 4A is in the third quadrant, and the contact location 62a illustrated in FIG. 4B is in the second quadrant.

The photoconductor drum 31 is one example of the image carrier, and the blade 62 is one example of the removing portion. The image forming unit 301 illustrated in FIG. 4A is one example of one set of the image forming section and is also one example of at least one image forming section of multiple sets of the image forming sections.

In each of the photoconductor drums 31 illustrated in FIGS. 4A and 4B, an angle at which a line segment 62b connecting the contact location 62a and the rotation axis 31b to each other intersects the imaginary horizontal plane H is considered. The angle is an angle θ1 in FIG. 4A and is an angle θ2 in FIG. 4B. The angle θ1 and the angle θ2 differ from each other. When positive-negative of the angle with respect to the imaginary horizontal plane H is defined such that the clockwise direction is a minus direction and the counterclockwise direction is a plus direction, the angle θ1 is in the plus direction and the angle θ2 is in the minus direction. The clockwise direction mentioned here is the same direction as the arrow A direction of the photoconductor drum 31, and the counterclockwise direction is the direction opposite to the arrow A direction. The direction of the arrow of the leader line of each of the angle θ1 and the angle θ2 in FIGS. 4A and 4B indicates whether the direction is the clockwise direction or the counterclockwise direction.

In the examples illustrated in FIGS. 4A and 4B, the absolute value of the angle θ1 is larger than the absolute value of the angle θ2, and in comparison using the positive and negative signs, the angle θ1 is larger than the angle θ2 (+θ1>−θ2).

The difference between the angle θ1 and the angle θ2 can be realized by shifting the entirety of the drum cleaner 34 in the up-down direction or shifting the photoconductor drum 31 in the circumferential direction.

The line segment 62b is one example of the line connecting the rotation axis of one image carrier and the first contact location to each other and is one example of the line connecting the rotation axis of another image carrier and the second contact location to each other.

As described above, the amount of the powder removed by the blade 62 is larger in the image forming unit 301 illustrated in FIG. 4A than in the image forming unit 302 illustrated in FIG. 4B. However, the contact location 62a is located below the imaginary horizontal plane H in the image forming unit 301. Therefore, the slope of the wall surface 611 of the body 61 in the image forming unit 301 is steep and may reduce the possibility of occurrence of accumulation of the powder removed by the blade 62.

The contact location 62a in the image forming unit 301 in FIG. 4A is one example of the first contact location, and the angle θ1 is one example of the first angle. The contact location 62a in the image forming unit 302 in FIG. 4B is one example of the second contact location, and the angle θ2 is one example of the second angle.

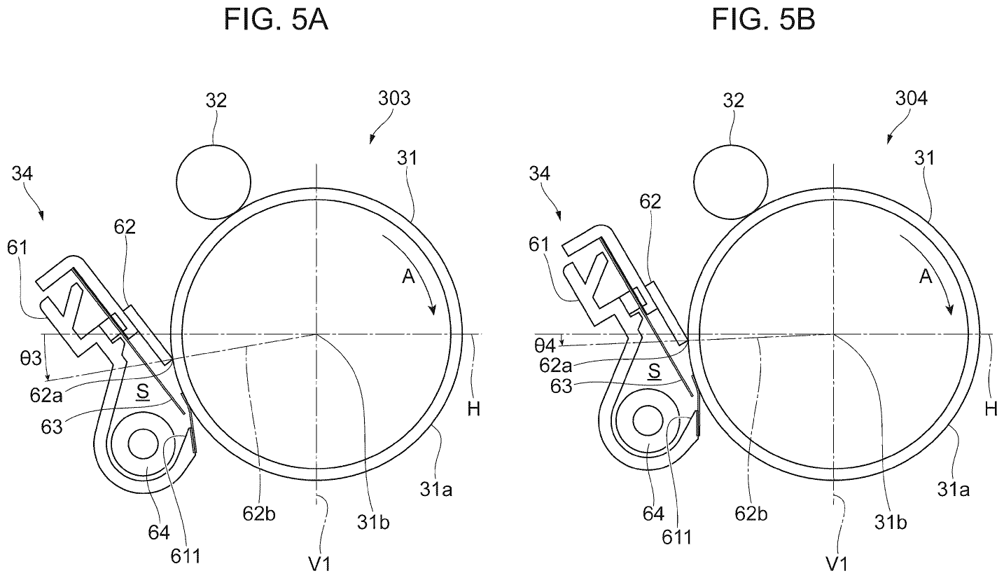

FIGS. 5A and 5B illustrate another example of the positional relationship between the photoconductor drum 31 and the drum cleaner 34 in multiple sets of the image forming units according to the first exemplary embodiment. FIGS. 5A and 5B illustrate one set of an image forming unit 303 and another set of an image forming unit 304, respectively, among multiple sets of the image forming units. FIGS. 5A and 5B correspond to FIGS. 4A and 4B, and illustration of the developing device 33 (see FIG. 1) and the like is also omitted in FIGS. 5A and 5B as in FIGS. 4A and 4B. Description of matters in FIGS. 5A and 5B common to those in FIGS. 4A and 4B may be omitted. The image forming unit 303 in FIG. 5A will be described assuming that the amount of powder removed by the blade 62 is larger in the image forming unit 303 than in the image forming unit 304 in FIG. 4B.

The contact location 62a in the image forming unit 303 illustrated in FIG. 5A is in the third quadrant, and the contact location 62a in the image forming unit 304 illustrated in FIG. 5B is also in the third quadrant. Such a matter is a difference from those in FIGS. 4A and 4B.

The angle at which the line segment 62b intersects the imaginary horizontal plane H is an angle θ3 in FIG. 5A, and the angle at which the line segment 62b intersects the imaginary horizontal plane H is an angle θ4 in FIG. 5B. The angle θ3 and the angle θ4 differ from each other. To describe further, the angle θ3 is larger than the angle θ4 (θ3>θ4). Therefore, the wall surface 611 of the body 61 in the image forming unit 303 has a steeper slope than the wall surface 611 in the image forming unit 304.

The difference between the angle θ3 and the angle θ4 can be realized by downwardly shifting the blade 62, which is a part of the drum cleaner 34, not by downwardly shifting the entirety of the drum cleaner 34.

The direction of the arrow of the leader line of each of the angle θ3 and the angle θ4 in FIGS. 5A and 5B indicates whether the direction is the clockwise direction or the counterclockwise direction.

As described above, the amount of the powder removed by the blade 62 is larger in the image forming unit 303 illustrated in FIG. 5A than in the image forming unit 304 illustrated in FIG. 5B. However, the contact location 62a is located below the imaginary horizontal plane H in the image forming unit 303. Therefore, the slope of the wall surface 611 of the body 61 in the image forming unit 303 is steep and may reduce the possibility of occurrence of accumulation of the powder removed by the blade 62.

The contact location 62a in the image forming unit 303 in FIG. 5A is one example of the first contact location, and the angle θ3 is one example of the first angle. The contact location 62a in the image forming unit 304 in FIG. 5B is one example of the second contact location, and the angle θ4 is one example of the second angle.

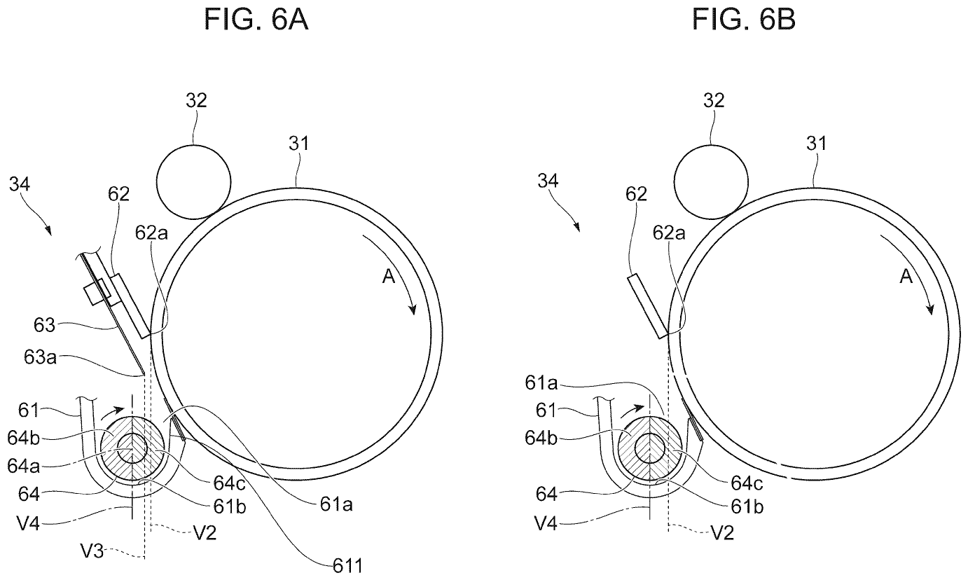

FIGS. 6A and 6B illustrate an example of the positional relationship between the blade 62 and the transport member 64 in the drum cleaner 34 according to the first exemplary embodiment. FIG. 6A illustrates one example with the partition member 63, and FIG. 6B illustrates another example without the partition member 63.

Here, in the body 61 illustrated in each of FIGS. 6A and 6B, the storage section 61a capable of storing powder is provided with the transport member 64. The transport member 64 rotates in the clockwise direction about an axis 64a present in the storage section 61a. The transport member 64 performs an equal-speed circular motion of rotating in one direction.

In one example illustrated in FIG. 6A, an imaginary vertical straight line V2 extending downward from the contact location 62a of the blade 62 passes through the transport member 64. In addition, in the one example illustrated in FIG. 6A, an imaginary vertical straight line V3 extending downward from a lower end 63a of the partition member 63 passes through the transport member 64. That is, the length of the partition member 63 is adjusted to be shortened such that the imaginary vertical straight line V3 passes through the transport member 64.

Therefore, the powder scraped off by the blade 62 does not slide on the wall surface of the body 61 and is piled up on the wall surface by being caused to fall onto the transport member 64 directly.

To describe further, in the one example illustrated in FIG. 6A, it is considered that the transport member 64 is divided into a left half 64b and a right half 64c by the imaginary vertical straight line V4 passing through the axis 64a of the transport member 64. The left half 64b is located away from the photoconductor drum 31. The right half 64c is located close to the photoconductor drum 31. The range of the left half 64b is indicated by diagonal lines slanting upward to the right. The range of the right half 64c is indicated by diagonal lines slanting downward to the right.

Since the transport member 64 rotates in the clockwise direction about the axis 64a, the left half 64b is a section in which the powder in the storage section 61a moves upward, and the right half 64c is a section in which the powder in the storage section 61a rotates downward. In other words, the right half 64c is a part in which the powder stored in the storage section 61a is moved toward a bottom 61b of the storage section 61a.

Since, as described above, the imaginary vertical straight lines V2 and V3 each pass through the right half 64c of the transport member 64, the powder that has fallen from the gap 67 (see FIG. 3) may be transported in the axial direction smoothly compared with when the imaginary vertical straight lines V2 and V3 each pass through the left half 64b.

The imaginary vertical straight line V2 is one example of the imaginary vertical straight line extending downward from the contact location, and the imaginary vertical straight line V3 is one example of the imaginary vertical straight line extending downward from the lower end of the arrangement member. The right half 64c is one example of the part in which the powder stored in the storage section is moved toward the bottom of the storage section.

The other example illustrated in FIG. 6B does not include the partition member 63 illustrated in FIG. 6A. Even in such a case, the imaginary vertical straight line V2 passes through the right half 64c, which is the right side of the transport member 64 with respect to the imaginary vertical straight line V4. Therefore, the powder that has fallen from the gap 67 may be transported in the axial direction smoothly.

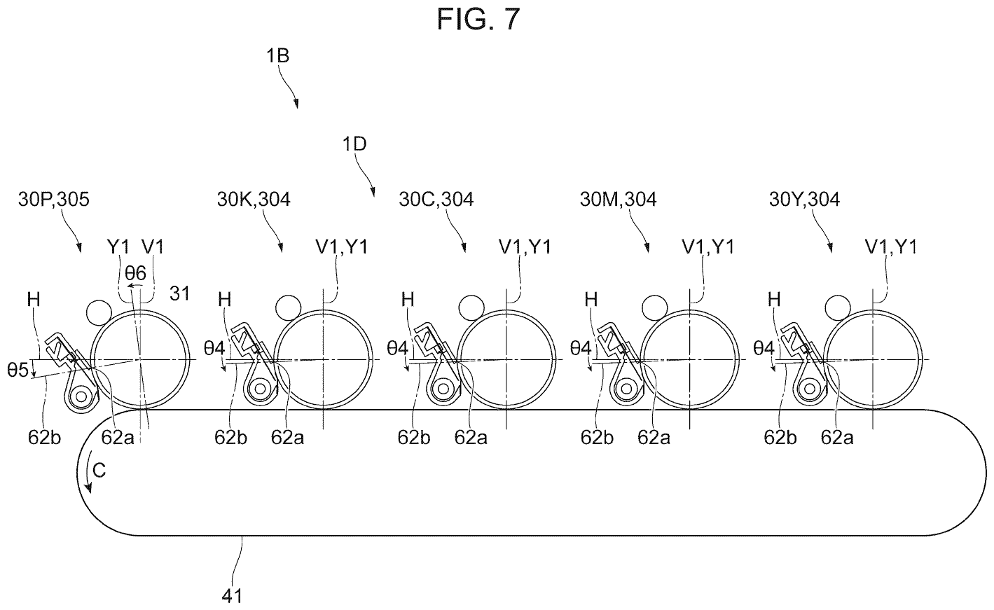

FIG. 7 illustrates one example of the arrangement of multiple sets of the image forming units according to the first exemplary embodiment with the intermediate transfer belt 41. Illustration of the developing device 33 (see FIG. 1) and the like is omitted in FIG. 7.

In the example illustrated in FIG. 7, the intermediate transfer belt 41 rotates in the arrow C direction, and multiple sets of the image forming units are arranged side by side laterally.

In the direction from the upstream side toward the downstream side of the intermediate transfer belt 41, the image forming units 30Y, 30M, 30C, 30K, and 30P are disposed in this order. That is, the image forming unit 30P that uses a special color toner to form a toner image is located on the most downstream side. The image forming unit 30T (see FIG. 1) is not disposed in FIG. 7 but may be disposed between the image forming unit 30K and the image forming unit 30P.

Focusing on the contact location 62a in the one example illustrated in FIG. 7, the contact location 62a is located below the imaginary horizontal plane H in the image forming unit 30P and is also located below the imaginary horizontal plane H in the image forming unit 30K. In each of the other image forming units 30Y, 30M, and 30C, the contact location 62a is also located below the imaginary horizontal plane H as in the image forming unit 30K.

Focusing on the angle at which the line segment 62b intersects the imaginary horizontal plane H in the one example illustrated in FIG. 7, the angle is an angle θ5 in the image forming unit 30P and is the angle θ4 in the image forming unit 30K. The angle θ5 is larger than the angle θ4 (θ5>θ4). In each of the other image forming units 30Y, 30M, and 30C, the angle is also the angle θ4 as in the image forming unit 30K.

As the image forming units 30Y, 30M, 30C, and 30K, the above-described image forming unit 304 (see FIG. 5B) is usable. For this reason, “304” is added to the sign of each of the image forming units 30Y, 30M, 30C, and 30K in FIG. 7.

The one example illustrated in FIG. 7 will be further described.

An up-down direction Y1 in the single image forming unit 30K is in the same direction as the imaginary vertical plane V1 when the image forming unit 30K is positioned with respect to the unit body ID of the printing unit 1B (see FIG. 1), and the up-down direction Y1 and the imaginary vertical plane V1 are parallel to each other. The up-down direction Y1 and the imaginary vertical plane V1 are in the same direction also in the image forming units 30Y, 30M, and 30C as in the image forming unit 30K. In FIG. 7, the imaginary vertical plane V1 and the up-down direction Y1 are illustrated in an overlapped manner in each of the image forming units 30Y, 30M, 30C, and 30K.

In contrast, the image forming unit 30P differs from the image forming unit 30K in that the up-down direction Y1 and the imaginary vertical plane V1 are not parallel to each other and intersect each other. In the image forming unit 30P, the up-down direction Y1 is inclined in the counterclockwise direction with respect to the imaginary vertical plane V1. That is, the entirety of the image forming unit 30P is rotated in the counterclockwise direction. The up-down direction Y1 in the image forming unit 30P intersects the imaginary vertical plane V1 at an angle θ6.

The angle θ6 mentioned here is the difference between the above-described angle θ5 of the image forming unit 30P and the above-described angle θ4 of the image forming unit 30K. In other words, the above-described angle θ5 of the image forming unit 30P has a value obtained by adding the angle θ4 of the image forming unit 30K to the angle θ6 of the image forming unit 30P.

Therefore, the image forming unit 30P differs from the above-described image forming unit 303 (see FIG. 5A). In FIG. 7, “305” instead of “303” is added to the sign of the image forming unit 30P.

Thus, the orientation of the image forming unit 30P with respect to the unit body ID and the orientation of each of the image forming units 30Y, 30M, 30C, and 30K with respect to the unit body 1D differ from each other. Consequently, it is configured such that the angle 05 of the image forming unit 30P and the angle θ4 of each of the image forming unit 30K and the other image forming units differ from each other. The angle θ5 is one example of the first angle and, as described above, the angle θ4 is one example of the second angle.

The orientation of the image forming unit 30P differs from the orientation of each of the image forming units 30Y, 30M, 30C, and 30K. That is, in the example illustrated in FIG. 7, the angle of mounting of the image forming unit 30P with respect to the unit body 1D differs from the angle of mounting of each of the image forming units 30Y, 30M, 30C, and 30K with respect to the unit body 1D. Consequently, even when the unit employed as each of the image forming units 30Y, 30M, 30C, and 30K and the unit employed as the image forming unit 30P are the same, it may be possible by adjusting the angle of mounting to cope with the image forming unit 30P in which a larger amount of powder is generated.

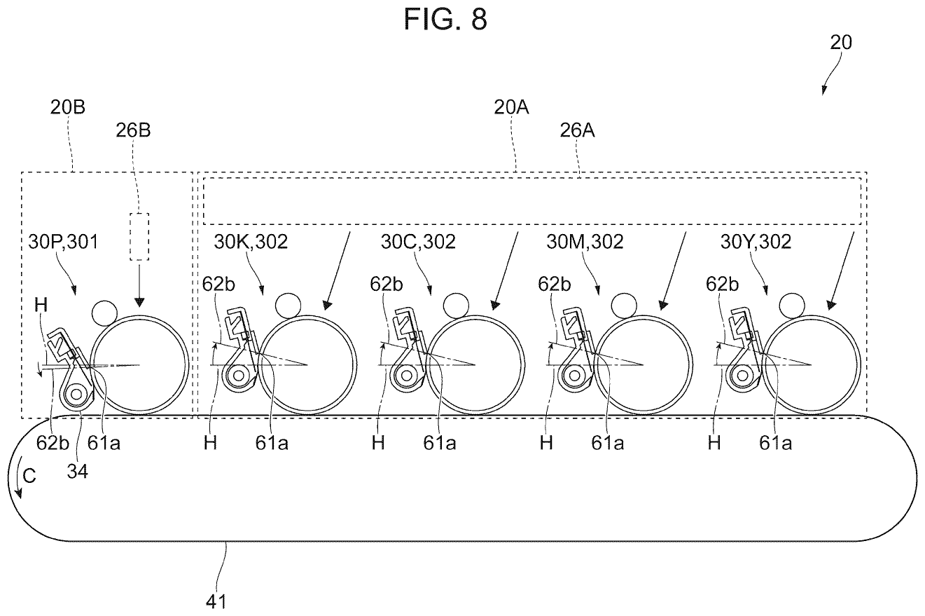

FIG. 8 illustrates another example of the arrangement of multiple sets of the image forming units according to the first exemplary embodiment with the intermediate transfer belt 41. Illustration of the developing device 33 (see FIG. 1) and the like is omitted in FIG. 8. In addition, description of the above-described signs included in the signs in FIG. 8 may be omitted.

In the example illustrated in FIG. 8, as in FIG. 7 mentioned above, the intermediate transfer belt 41 rotates in the arrow C direction, and the image forming units 30Y, 30M, 30C, 30K, and 30P are disposed in this order in the direction from the upstream side toward the downstream side of the intermediate transfer belt 41.

In the example illustrated in FIG. 8, the image forming section 20 includes a first image forming section 20A including the image forming units 30Y, 30M, 30C, and 30K, and a second image forming section 20B including the image forming unit 30P.

The first image forming section 20A includes a laser exposure device 26A, and the second image forming section 20B includes a laser exposure device 26B. In the first image forming section 20A, the photoconductor drum 31 of each of the image forming units 30Y, 30M, 30C, and 30K is exposed with light by the laser exposure device 26A. In the second image forming section 20B, the photoconductor drum 31 of the image forming unit 30P is exposed with light by the laser exposure device 26B.

The laser exposure device 26A and the laser exposure device 26B differ from each other in terms of method of exposure.

The laser exposure device 26A includes, inside an optical box, for example, a rotating polygon mirror, a scanning lens, a folding mirror, a separating polygon mirror, a reflecting mirror, and a cylindrical mirror. The laser exposure device 26A obtains image data for each color from the image processor 22 (see FIG. 1). The laser exposure device 26A then scans and exposes the photoconductor drum 31 of each of the image forming units 30Y, 30M, 30C, and 30K with four beams of laser light controlled to be turned on and off on the basis of the obtained image data.

The laser exposure device 26B includes an LED array with multiple light emitting elements; a circuit board on which the LED array, a circuit that drives the LED array, and the like are mounted; and a rod lens array that causes light emitted from the LED array to form an image on the surface of the photoconductor drum 31. The laser exposure device 26B is disposed vertically above the photoconductor drum 31 and exposes the photoconductor drum 31 with light from vertically above.

As each of the image forming units 30Y, 30M, 30C, and 30K of the first image forming section 20A, the above-described image forming unit 302 (see FIG. 4B) is usable. For this reason, “302” is added to the sign of each of the image forming units 30Y, 30M, 30C, and 30K in FIG. 8.

As the image forming unit 30P of the second image forming section 20B, the above-described image forming unit 301 (see FIG. 4A) is usable. Therefore, “301” is added to the sign of the image forming unit 30P in FIG. 8.

To describe further, in the second image forming section 20B, the drum cleaner 34 of the image forming unit 30P is disposed at a location shifted in the counterclockwise direction compared with, for example, the image forming unit 30K. In the second image forming section 20B, the laser exposure device 26B is provided in a space that is formed above the image forming unit 30P as a result of such arrangement.

The second image forming section 20B includes the image forming unit 30P that forms a toner image by using a special color toner, and the laser exposure device 26B for exposure of the image forming unit 30P. Therefore, it may be possible to easily add the second image forming section 20B to the image forming apparatus 1 that performs printing with only YMCK colors.

### Second Exemplary Embodiment

Next, the second exemplary embodiment will be described.

Here, the powder scraped off by the blade 62 in the image forming unit 30 illustrated in FIG. 3 moves downward from the accumulation section 66 through the gap 67 to be stored in the storage section 61a.

However, when the amount of the powder scraped off by the blade 62 is large, the powder accumulated in the accumulation section 66 may have difficulty in moving downward from the gap 67. When the amount of the powder in the accumulation section 66 is increased, the tip portion 65a of the contact member 65 is pressed toward the photoconductor drum 31. Then, the powder does not easily pass through the gap between the tip portion 65a of the contact member 65 and the surface 31a of the photoconductor drum 31. Consequently, a situation in which the powder on the surface 31a is scraped off by the tip portion 65a directly may occur. The powder scraped off by the tip portion 65a of the contact member 65 is likely to stain the image forming units 30, the intermediate transfer belt 41, and the like.

The amount of the powder scraped off by the blade 62 is not always the same among multiple sets of the image forming units and different depending on, for example, the ratios of toners of developed images. For example, the amount of the powder scraped off by the blade 62 may be also different among the image forming units 30Y, 30M, 30C, and 30K. In addition, the amount of the powder scraped in each of the multiple sets of the image forming units is generally larger in each of the image forming units 30T and 30P than in the image forming units 30Y, 30M, 30C, and 30K.

It is considered that the capacity of the storage section 61a is set to be the same between each of the image forming units in which the amount of the scraped powder is large and each of the image forming units in which the amount of the scraped powder is small. In each of the image forming units in which the amount of the scraped powder is large, the upper surface of the powder stored in the storage section 61a becomes high to approach the gap 67, and storage of the powder becomes impossible. Consequently, it may become difficult for powder to pass through the gap 67 and may decrease the scraping performance of scraping powder from the surface 31a of the photoconductor drum 31 by the blade 62.

Here, it may be possible in the second exemplary embodiment to suppress a decrease in the removing performance by reducing the possibility of occurrence of a situation in which the powder is stored in the storage section 61a to a height that makes it difficult for powder to pass through the gap 67.

FIGS. 9A and 9B illustrate one example of the drum cleaner 34 in multiple sets of the image forming units according to the second exemplary embodiment. FIGS. 9A and 9B illustrate, among multiple sets of the image forming units, one set of an image forming unit 306 and another set of an image forming unit 307, respectively. Illustration of the developing device 33 (see FIG. 1) and the like is omitted in FIGS. 9A and 9B. The image forming unit 307 in FIG. 9B will be described assuming that the amount of powder removed by the blade 62 is larger in the image forming unit 307 than in the image forming unit 306 in FIG. 9A.

The photoconductor drum 31 of the image forming unit 306 illustrated in FIG. 9A and the photoconductor drum 31 of the image forming unit 307 illustrated in FIG. 9B are the same with each other in terms of position or height position in the up-down direction Y1.

The relationship between the drum cleaner 34 of the image forming unit 306 and the drum cleaner 34 of the image forming unit 307 will be described together with the positional relationship thereof with respect to the photoconductor drum 31. As described above, the drum cleaner 34 includes the body 61, the blade 62, the partition member 63, and the transport member 64. In FIGS. 9A and 9B, the body 61 of the image forming unit 306 and the body 61 of the image forming unit 307 are the same with each other.

The positional relationship between the photoconductor drum 31 and the partition member 63 in the image forming unit 306 and the positional relationship between the photoconductor drum 31 and the partition member 63 in the image forming unit 307 differ from each other.

More specifically, the image forming unit 306 and the image forming unit 307 differ from each other in terms of the position of the lower end 63a of the partition member 63 in the up-down direction Y1. The lower end 63a of the image forming unit 307 is located above the lower end 63a of the image forming unit 306. As illustrated in FIGS. 9A and 9B, when an imaginary horizontal plane H1 passing through the lower end 63a of the image forming unit 306 is compared with an imaginary horizontal plane H2 passing through the lower end 63a of the image forming unit 307, the imaginary horizontal plane H2 is located at a higher position than the imaginary horizontal plane H1.

The height position of each of the imaginary horizontal planes H1 and H2 is one example of the position of the lower end portion of the arrangement member in the up-down direction.

The positional relationship between the photoconductor drum 31 and the body 61 in the image forming unit 306 and the positional relationship between the photoconductor drum 31 and the body 61 in the image forming unit 307 are the same with each other.

More specifically, the image forming unit 306 and the image forming unit 307 are the same with each other in terms of the position of a lower end portion 61c of the body 61 in the up-down direction Y1. As illustrated in FIGS. 9A and 9B, an imaginary horizontal plane H3 passing through the lower end portion 61c of the image forming unit 306 passes through the lower end portion 61c of the image forming unit 307.

When the height difference between the imaginary horizontal plane H1 and the imaginary horizontal plane H3 is defined as a distance L1 and the height difference between the imaginary horizontal plane H2 and the imaginary horizontal plane H3 is defined as a distance L2, the distance L2 is longer than the distance L1 (L2>L1).

Each of the distances L1 and L2 is one example of the length between the lower end portion of the arrangement member and the lower end of the storage section in the up-down direction.

The position of the blade 62 in the up-down direction Y1 is different between the image forming unit 306 and the image forming unit 307 in the example illustrated in FIGS. 9A and 9B but may be considered to be set to be the same therebetween.

The capacity of the storage section 61a of the body 61 in FIGS. 9A and 9B will be described.

The image forming unit 306 and the image forming unit 307 differ from each other in terms of the amount of powder that can be stored in the storage section 61a. That is, the capacity of the storage section 61a in the image forming unit 306 and the capacity of the storage section 61a in the image forming unit 307 differ from each other.

More specifically, the amount of powder that can be stored in the storage section 61a of the image forming unit 307 is larger than the amount of powder that can be stored in the storage section 61a of the image forming unit 306. This is because, as described above, the amount of powder removed by the blade 62 is larger in the image forming unit 307 than in the image forming unit 306.

Such a configuration may reduce the possibility of occurrence of a situation in which powder is stored in the storage section 61a to a height that makes it difficult for powder to pass through the gap 67 (see, for example, FIG. 3).

The capacity of the storage section 61a of either one of the image forming unit 306 and the image forming unit 307 is one example of the capacity of one storage section, and the capacity of the storage section 61a of the other one of the image forming unit 306 and the image forming unit 307 is one example of the capacity of another storage section.

As illustrated in FIGS. 9A and 9B, such different capacities may be considered to be realized as one form of the different capacities by the positional relationship between the storage section 61a and the imaginary horizontal plane H1 in the image forming unit 306 and the positional relationship between the storage section 61a and the imaginary horizontal plane H2 in the image forming unit 307. That is, the capacity of a part R1 of the storage section 61a located below the imaginary horizontal plane H1 and the capacity of a part R2 of the storage section 61a located below the imaginary horizontal plane H2 differ from each other. The capacity of the part R2 is larger than the capacity of the part R1 (R2>R1).

Here, in FIGS. 9A and 9B, the body 61 of the image forming unit 306 and the body 61 of the image forming unit 307 are the same with each other, as described above. In addition, as described above, the imaginary horizontal plane H3 passes through the lower end portion 61c of the image forming unit 306 and also passes through the lower end portion 61c of the image forming unit 307. Thus, in order to make the capacities different between FIGS. 9A and 9B, the position of the lower end 63a of the partition member 63 in the up-down direction Y1 is set to be different between the image forming unit 306 and the image forming unit 307.

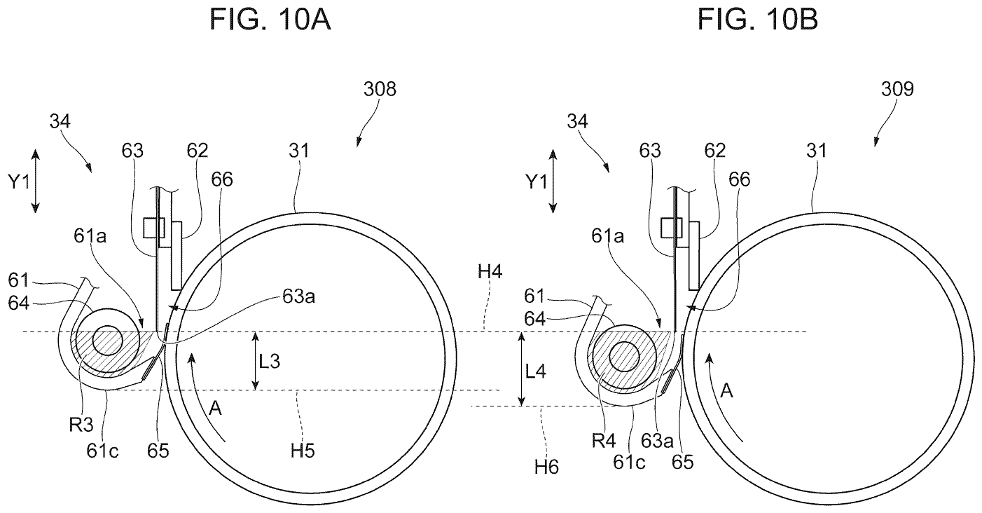

FIGS. 10A and 10B illustrate another example of the drum cleaner 34 in multiple sets of the image forming units according to the second exemplary embodiment. FIGS. 10A and 10B illustrate, among multiple sets of the image forming units, one set of an image forming unit 308 and another set of an image forming unit 309, respectively. The image forming unit 309 in FIG. 10B will be described assuming that the amount of powder removed by the blade 62 is larger in the image forming unit 309 than in the image forming unit 308 in FIG. 10A.

The photoconductor drum 31 of the image forming unit 308 illustrated in FIG. 10A and the photoconductor drum 31 of the image forming unit 309 illustrated in FIG. 9B are the same with each other in terms of position or height position in the up-down direction Y1.

The positional relationship between the photoconductor drum 31 and the partition member 63 in the image forming unit 308 and the positional relationship between the photoconductor drum 31 and the partition member 63 in the image forming unit 309 are the same with each other.

More specifically, the image forming unit 308 and the image forming unit 309 are the same with each other in terms of the position of the lower end 63a of the partition member 63 in the up-down direction Y1. As illustrated in FIGS. 10A and 10B, an imaginary horizontal plane H4 passing through the lower end 63a in the image forming unit 308 passes through the lower end 63a in the image forming unit 309.

The positional relationship between the photoconductor drum 31 and the body 61 in the image forming unit 308 and the positional relationship between the photoconductor drum 31 and the body 61 in the image forming unit 309 differ from each other.

More specifically, the image forming unit 308 and the image forming unit 309 differ from each other in terms of the position of the lower end portion 61c of the body 61 in the up-down direction Y1. The lower end portion 61c in the image forming unit 309 is located below the lower end portion 61c in the image forming unit 308. As illustrated in FIGS. 10A and 10B, when an imaginary horizontal plane H5 passing through the lower end portion 61c in the image forming unit 308 is compared with an imaginary horizontal plane H6 passing through the lower end portion 61c in the image forming unit 309, the imaginary horizontal plane H6 is located at a lower position than the imaginary horizontal plane H5.

The position of the lower end portion 61c of the body 61 in the up-down direction is one example of the position of the lower end of the storage section.

When the height difference between the imaginary horizontal plane H4 and the imaginary horizontal plane H5 is defined as a distance L3 and the height difference between the imaginary horizontal plane H4 and the imaginary horizontal plane H6 is defined as a distance L4, the distance L4 is longer than the distance L3 (L4>L3).

Each of the distances L3 and L4 is one example of the length between the lower end portion of the arrangement member and the lower end of the storage section in the up-down direction.

In the example illustrated in FIGS. 10A and 10B, the image forming unit 308 and the image forming unit 309 differ from each other in terms of the body 61. That is, the size of the storage section 61a of the image forming unit 309 is larger than the size of the storage section 61a of the image forming unit 308 but is not limited thereto. The storage section 61a of the image forming unit 308 and the storage section 61a of the image forming unit 309 may be considered to be set to have the same sizes.

The capacity of the storage section 61a of the body 61 in FIGS. 10A and 10B will be described.

The image forming unit 308 and the image forming unit 309 differ from each other in terms of the amount of powder that can be stored in the storage section 61a. That is, the capacity of the storage section 61a in the image forming unit 308 and the capacity of the storage section 61a in the image forming unit 309 differ from each other.

More specifically, the amount of powder that can be stored in the storage section 61a of the image forming unit 309 is larger than the amount of powder that can be stored in the storage section 61a of the image forming unit 308. This is because, as described above, the amount of powder removed by the blade 62 is larger in the image forming unit 309 than in the image forming unit 308.

The capacity of the storage section 61a of either one of the image forming unit 308 and the image forming unit 309 is one example of the capacity of one storage section, and the capacity of the storage section 61a of the other one of the image forming unit 308 and the image forming unit 309 is one example of the capacity of the other storage section.

As illustrated in FIGS. 10A and 10B, such different capacities may considered to be realized as one form of the different capacities by the positional relationship between the storage section 61a and the imaginary horizontal plane H5 in the image forming unit 308 and the positional relationship between the storage section 61a and the imaginary horizontal plane H6 in the image forming unit 309. That is, the capacity of a part R3 of the storage section 61a located above the imaginary horizontal plane H5 and the capacity of a part R4 of the storage section 61a located above the imaginary horizontal plane H6 differ from each other. The capacity of the part R4 is larger than the capacity of the part R3 (R4>R3). Here, in FIGS. 10A and 10B, the imaginary horizontal plane H4 passes through the lower end 63a of the image forming unit 308 and also passes through the lower end 63a of the image forming unit 309, as described above. Thus, in order to make the capacities different from each other in FIGS. 10A and 10B, the position of the lower end portion 61c of the body 61 in the up-down direction Y1 is set to be different between the image forming unit 308 and the image forming unit 309.

The part that forms the storage section 61a of the body 61 is configured to be different between the image forming unit 308 and the image forming unit 309 in FIGS. 10A and 10B but may be considered to be set to be the same therebetween.

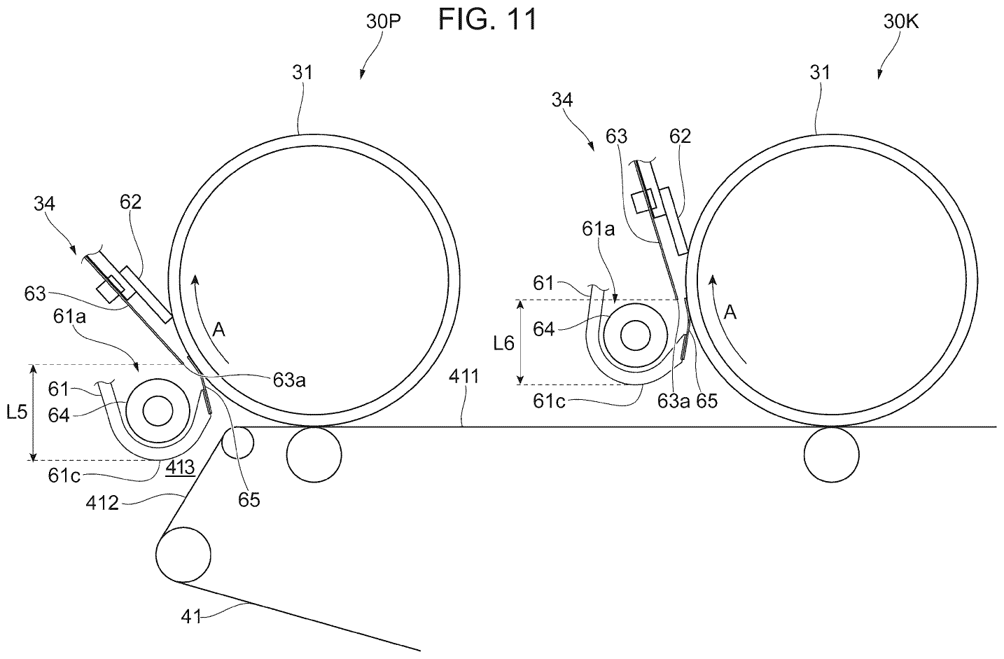

FIG. 11 illustrates one example of the arrangement of multiple sets of the image forming units according to the second exemplary embodiment with the intermediate transfer belt 41. Illustration of the developing device 33 (see FIG. 1) and the like is omitted in FIG. 11. The intermediate transfer belt 41 is one example of the transfer member.

In the example illustrated in FIG. 11, the intermediate transfer belt 41 rotates in the arrow C direction, and multiple sets of the image forming units are arranged side by side laterally. In FIG. 11, the image forming units 30K and 30P are illustrated and illustration of the other image forming units 30Y, 30M, 30C, and the like is omitted. The image forming unit 30T (see FIG. 1) is not disposed in FIG. 11 but may be disposed between the image forming unit 30K and the image forming unit 30P.

The intermediate transfer belt 41 is provided with a facing part 411 disposed at a location to face the image forming units 30K and 30P, and an inclined part 412 connected to the facing part 411 to extend obliquely downward.

In the example illustrated in FIG. 11, the image forming unit 30K is disposed at the facing part 411 of the intermediate transfer belt 41. The storage section 61a of the image forming unit 30P is disposed at a location opposite the inclined part 412.

As described above, the amount of powder generated in the image forming unit 30P is larger than the amount of powder generated in the image forming unit 30K. When the storage section 61a of the image forming unit 30P is disposed at the facing part 411, the size of the storage section 61a is limited in order to avoid interference with the intermediate transfer belt 41.

By providing the intermediate transfer belt 41 with the inclined part 412, a space 413 is formed on the front surface side of the intermediate transfer belt 41. In the one example illustrated in FIG. 11, such a space 413 is used to provide the storage section 61a of the image forming unit 30P at a location opposite the inclined part 412. Consequently, the capacity of the storage section 61a may be increased without limiting the size of the storage section 61a in the image forming unit 30P.

More details will be described.

As illustrated in FIG. 11, the height difference between the lower end 63a of the partition member 63 and the lower end portion 61c of the body 61 in the image forming unit 30P is defined as a distance L5. The height difference between the lower end 63a of the partition member 63 and the lower end portion 61c of the body 61 in the image forming unit 30K is defined as a distance L6.

The distance L5 in the image forming unit 30P is longer than the distance L6 in the image forming unit 30K (L5>L6).

In addition, as illustrated in FIG. 11, a part of the body 61 forming the storage section 61a in the image forming unit 30P is larger than a part of the body 61 forming the storage section 61a in the image forming unit 30K.

Thus, in the one example illustrated in FIG. 11, the capacity of the storage section 61a in the image forming unit 30P is larger than the capacity of the storage section 61a in the image forming unit 30K.

The storage section 61a of either one of the image forming units 30K and 30P is one example of one storage section in one set and the storage section 61a of the other one of the image forming units 30K and 30P is one example of another storage section in another set.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming apparatus comprising:
an image carrier that is provided to be rotatable about a rotation axis and that carries an image; and
a removing portion that removes powder adhering to an outer peripheral surface of the image carrier by coming into contact with the outer peripheral surface of the image carrier that rotates,
wherein one set of an image forming section that includes the image carrier and the removing portion and that forms an image is provided or a plurality of sets of the image forming sections are provided, and
wherein, in the one set of the image forming section or in at least one image forming section among the plurality of sets of the image forming sections, a contact location that is a location at which the removing portion comes into contact with the outer peripheral surface of the image carrier is located below an imaginary horizontal plane passing through the rotation axis of the image carrier.
   (((2)))

The image forming apparatus according to (((1))),
wherein a plurality of sets of the image forming sections are provided, and
wherein, when it is defined
   that the image carrier of the one image forming section in which the contact location is located below the imaginary horizontal plane is one image carrier,
   that the removing portion of the one image forming section in which the contact location is located below the imaginary horizontal plane is one removing portion,
   that the contact location at which the one removing portion comes into contact with the outer peripheral surface of the one image carrier is a first contact location, and
   that a location at which another removing portion, the other removing portion being the removing portion provided to correspond to another image carrier that is the image carrier of another image forming section among the plurality of sets of the image forming sections, comes into contact with the outer peripheral surface of the other image carrier is a second contact location,
   a first angle that is an angle at which a line connecting the rotation axis of the one image carrier and the first contact location to each other intersects the imaginary horizontal plane differs from a second angle that is an angle at which a line connecting the rotation axis of the other image carrier and the second contact location to each other intersects the imaginary horizontal plane of the one image carrier.
      (((3)))

The image forming apparatus according to (((2))),
wherein an orientation of the one image forming section with respect to a body of the image forming apparatus differs from an orientation of the other image forming section with respect to the body of the image forming apparatus to cause the first angle to differ from the second angle.
   (((4)))

The image forming apparatus according to any one of (((1))) to (((3))), comprising:
a storage section that stores powder removed by the removing portion and moving downward; and
a transport portion that transports powder stored in the storage section in an axial direction by rotating about an axis,
wherein the image forming section further includes the storage section and the transport portion, and
wherein an imaginary vertical straight line extending downward from the contact location passes through the transport portion.
   (((5)))

The image forming apparatus according to (((4))), comprising:
a formation member that forms a space between the formation member and the outer peripheral surface of the image carrier, the space temporarily holding powder removed by the removing portion, and that forms a gap through which powder in the space passes downward, the formation member being disposed at a location to face the image carrier,
wherein the image forming section further includes the formation member, and
wherein an imaginary vertical straight line extending downward from a lower end of the formation member passes through the transport portion.
   (((6)))

The image forming apparatus according to (((5))),
wherein the imaginary vertical straight line passes through a part of the transport portion, the part being a part through which powder stored in the storage section is moved toward a bottom of the storage section.
   (((7)))

An image forming apparatus comprising:
an image carrier that is provided to be rotatable and that carries an image;
a scraping portion that scrapes off powder adhering to an outer peripheral surface of the image carrier, the scraping portion being disposed to be in contact with the outer peripheral surface of the image carrier that rotates;
an arrangement member that is disposed with a gap provided between the arrangement member and the outer peripheral surface of the image carrier and that includes at least a portion disposed below the scraping portion; and
a storage section that stores powder scraped off by the scraping portion and moving downward through the gap,
wherein a plurality of sets each including the image carrier, the scraping portion, the arrangement member, and the storage section are provided, and
wherein a capacity of one storage section that is the storage section in one set among the plurality of sets differs from a capacity of another storage section that is the storage section in another set among the plurality of sets.
   (((8)))

The image forming apparatus according to (((7))),
wherein a capacity of a part of the one storage section, the part being located below a horizontal plane passing through a lower end portion of the arrangement member provided to correspond to the one storage section, differs from a capacity of a part of the other storage section, the part being located below a horizontal plane passing through a lower end portion of the arrangement member provided to correspond to the other storage section.
   (((9)))

The image forming apparatus according to (((8))),
wherein a position of a lower end portion of the arrangement member provided to correspond to the one storage section in an up-down direction differs from a position of a lower end portion of the arrangement member provided to correspond to the other storage section in the up-down direction.
   (((10)))

The image forming apparatus according to any one of (((7))) to (((9))),
wherein a length in an up-down direction between a lower end portion of the arrangement member provided to correspond to the one storage section and a lower end of the one storage section differs from a length in the up-down direction between a lower end portion of the arrangement member provided to correspond to the other storage section and a lower end of the other storage section.
   (((11)))

The image forming apparatus according to (((10))),
wherein a position of a lower end of the one storage section differs from a position of a lower end of the other storage section.
   (((12)))

The image forming apparatus according to any one of (((7))) to (((11))),
wherein a plurality of sets of image forming sections that each include the image carrier, the scraping portion, the arrangement member, and the storage section and that each form an image are provided,
wherein the image forming apparatus comprises a transfer member that circularly moves to cause an image formed on the image carrier provided in each of the image forming sections to be transferred onto the transfer member,
wherein a plurality of sets of the image forming sections are arranged side by side laterally,
wherein the transfer member is provided with a facing part that extends laterally and that is disposed at a location to face the plurality of sets of the image forming sections, and an inclined part that is connected to the facing part and that extends downward obliquely, and
wherein the storage section provided in at least one image forming section among the plurality of sets of the image forming sections is at a location to face the inclined part.

What is claimed is:

1. An image forming apparatus comprising:
an image carrier that is provided to be rotatable about a rotation axis and that carries an image; and
a removing portion that removes powder adhering to an outer peripheral surface of the image carrier by coming into contact with the outer peripheral surface of the image carrier that rotates,
wherein one set of an image forming section that includes the image carrier and the removing portion and that forms an image is provided or a plurality of sets of the image forming sections are provided, and
wherein, in the one set of the image forming section or in at least one image forming section among the plurality of sets of the image forming sections, a contact location that is a location at which the removing portion comes into contact with the outer peripheral surface of the image carrier is located below an imaginary horizontal plane passing through the rotation axis of the image carrier.

2. The image forming apparatus according to claim 1,
wherein a plurality of sets of the image forming sections are provided, and
wherein, when it is defined
that the image carrier of the one image forming section in which the contact location is located below the imaginary horizontal plane is one image carrier,
that the removing portion of the one image forming section in which the contact location is located below the imaginary horizontal plane is one removing portion,
that the contact location at which the one removing portion comes into contact with the outer peripheral surface of the one image carrier is a first contact location, and
that a location at which another removing portion, the other removing portion being the removing portion provided to correspond to another image carrier that is the image carrier of another image forming section among the plurality of sets of the image forming sections, comes into contact with the outer peripheral surface of the other image carrier is a second contact location,
a first angle that is an angle at which a line connecting the rotation axis of the one image carrier and the first contact location to each other intersects the imaginary horizontal plane differs from a second angle that is an angle at which a line connecting the rotation axis of the other image carrier and the second contact location to each other intersects the imaginary horizontal plane of the one image carrier.

3. The image forming apparatus according to claim 2,
wherein an orientation of the one image forming section with respect to a body of the image forming apparatus differs from an orientation of the other image forming section with respect to the body of the image forming apparatus to cause the first angle to differ from the second angle.

4. The image forming apparatus according to claim 1, comprising:
a storage section that stores powder removed by the removing portion and moving downward; and
a transport portion that transports powder stored in the storage section in an axial direction by rotating about an axis,
wherein the image forming section further includes the storage section and the transport portion, and
wherein an imaginary vertical straight line extending downward from the contact location passes through the transport portion.

5. The image forming apparatus according to claim 4, comprising:
a formation member that forms a space between the formation member and the outer peripheral surface of the image carrier, the space temporarily holding powder removed by the removing portion, and that forms a gap through which powder in the space passes downward, the formation member being disposed at a location to face the image carrier,
wherein the image forming section further includes the formation member, and
wherein an imaginary vertical straight line extending downward from a lower end of the formation member passes through the transport portion.

6. The image forming apparatus according to claim 5,
wherein the imaginary vertical straight line passes through a part of the transport portion, the part being a part through which powder stored in the storage section is moved toward a bottom of the storage section.

7. An image forming apparatus comprising:
an image carrier that is provided to be rotatable and that carries an image;
a scraping portion that scrapes off powder adhering to an outer peripheral surface of the image carrier, the scraping portion being disposed to be in contact with the outer peripheral surface of the image carrier that rotates;
an arrangement member that is disposed with a gap provided between the arrangement member and the outer peripheral surface of the image carrier and that includes at least a portion disposed below the scraping portion; and
a storage section that stores powder scraped off by the scraping portion and moving downward through the gap,
wherein a plurality of sets each including the image carrier, the scraping portion, the arrangement member, and the storage section are provided, and
wherein a capacity of one storage section that is the storage section in one set among the plurality of sets differs from a capacity of another storage section that is the storage section in another set among the plurality of sets.

8. The image forming apparatus according to claim 7,
wherein a capacity of a part of the one storage section, the part being located below a horizontal plane passing through a lower end portion of the arrangement member provided to correspond to the one storage section, differs from a capacity of a part of the other storage section, the part being located below a horizontal plane passing through a lower end portion of the arrangement member provided to correspond to the other storage section.

9. The image forming apparatus according to claim 8,
wherein a position of a lower end portion of the arrangement member provided to correspond to the one storage section in an up-down direction differs from a position of a lower end portion of the arrangement member provided to correspond to the other storage section in the up-down direction.

10. The image forming apparatus according to claim 7,
wherein a length in an up-down direction between a lower end portion of the arrangement member provided to correspond to the one storage section and a lower end of the one storage section differs from a length in the up-down direction between a lower end portion of the arrangement member provided to correspond to the other storage section and a lower end of the other storage section.

11. The image forming apparatus according to claim 10,
wherein a position of a lower end of the one storage section differs from a position of a lower end of the other storage section.

12. The image forming apparatus according to claim 7,
wherein a plurality of sets of image forming sections that each include the image carrier, the scraping portion, the arrangement member, and the storage section and that each form an image are provided,
wherein the image forming apparatus comprises a transfer member that circularly moves to cause an image formed on the image carrier provided in each of the image forming sections to be transferred onto the transfer member,
wherein a plurality of sets of the image forming sections are arranged side by side laterally,
wherein the transfer member is provided with a facing part that extends laterally and that is disposed at a location to face the plurality of sets of the image forming sections, and an inclined part that is connected to the facing part and that extends downward obliquely, and
wherein the storage section provided in at least one image forming section among the plurality of sets of the image forming sections is at a location to face the inclined part.
